(19) United States
(12) Patent Application Publication
(10) Pub. No.: US 2003/0183376 A1
(43) Pub. Date: Oct. 2, 2003

(54) High strength CAB brazed heat exchangers using high strength fin materials

(76) Inventors: Bradley David Abell, Ann Arbor, MI (US); Jeff Scott Southwood, Ann Arbor, MI (US); Timothy Van Evans, Ypsilanti, MI (US)

Correspondence Address: BRINKS HOFER GILSON & LIONE, P.O. BOX 10395, CHICAGO, IL, 60611, US

(21) Appl. No.: 10/114,905

(22) Filed: Apr. 2, 2002

(51) Int. Cl. F28F 13/12; F28F 13/18; F28F 19/02; B23P 15/26; B23K 31/00

(52) U.S. Cl. 165/133; 165/109.1; 29/890.054

(57) ABSTRACT

A heat exchanger assembly that includes a tube having an internal surface and an external surface. An aluminum-based component is disposed adjacent to the tube, the aluminum-based component has an aluminum-based material that has a magnesium content that is above 0.3%, wherein the aluminum-based component is joined to the tube using a brazing flux applied during a controlled atmosphere brazing process.

### BACKGROUND OF THE INVENTION

1. Field of the Invention

The present invention relates to a heat exchanger for automotive vehicles manufactured by controlled atmosphere brazing (“CAB”). In particular, the present invention regards the use of fin materials containing a higher than normal amount of magnesium (“Mg”) to add strength to the heat exchanger while maintaining an adequate fin-to-tube brazing bond or fillet that is required for excellent heat transfer.

2. Discussion of Related Art

It is known to provide automotive vehicles with heat exchangers such as condensers, evaporators, heater cores and coolers generally made of aluminum or aluminum alloys. These heat exchangers are alternating rows of tubes or plates to facilitate fluid transfer through the heat exchanger. The heat exchangers often include convoluted fins brazed to the external surfaces of the tubes to provide increased surface area to enhance heat transfer with the air passing over the heat exchanger. Additionally, tanks, headers and side supports are used to construct the heat exchanger.

As described in U.S. Pat. No. 5,771,962, the entire contents of which are incorporated herein by reference, one known process for brazing the fins to the tubes and turbulators is a process known as “controlled atmosphere brazing” (CAB). When the CAB process is employed with heat exchangers made of aluminum or aluminum alloys, the fins typically are made of 3xxx series aluminum that contains a very low level of magnesium, such as 0.3 percent. It is generally understood that when levels of magnesium higher than 0.3% are contained in aluminum heat exchanger components the interaction between the magnesium and the KALF flux known as NOCOLOK prevents the bond or fillet between the heat exchanger components from occurring and thereby foiling the CAB process. Thus, when the magnesium level in the fin material exceeds 0.3 percent, the CAB process will not bond the fins to the tubes, which reduces heat transfer performance and heat exchanger structural integrity.

Faced with the above competing interests—improving brazing attachment versus improving fin strength, several solutions have been proposed. One proposed solution is to use a triple clad material to provide a boundary between a high magnesium bearing base material and the outer clad layer. Such a structure is known to be sold by Finspong Heat Transfer AB of Sweden. This structure limits the amount of high strength material contained in the tube alloy due to the minimal thicknesses being used in tube production. This leads to a tube alloy with minimal increases in strength.

A second proposed structure is to limit the amount of magnesium allowed in the aluminum used to form the heat exchanger that lies below 0.3%. This trace amount of magnesium does not interfere with the flux and allows it to break down the aluminum oxide layer on the surface of the components, which enables the bond or fillets to form between the components that make up the heat exchanger. While the bond or fillets are formed with this magnesium content, the strength characteristics of the fin are limited. To overcome this limitation, the fin is made thicker by increasing the material's gage to provide the required strength. One disadvantage of such a proposal is that increasing the gage thickness results in increasing weight and cost for the heat exchanger.

In view of the above-described disadvantages, it is an object of the present invention to provide a heat exchanger that uses a fin material that is higher in strength than fin materials that are used with known CAB processes.

Another object of the present invention is to maintain the strength of a heat exchanger while also reducing in weight and cost the heat exchanger.

### SUMMARY OF THE INVENTION

One aspect of the present invention regards a heat exchanger assembly that includes a tube having an internal surface and an external surface. An aluminum-based component is disposed adjacent to the tube, the aluminum-based component has an aluminum-based material that has a magnesium content that is above 0.3%, wherein the aluminum-based component is joined to the tube using a brazing flux applied during a controlled atmosphere brazing process.

A second aspect of the present invention regards a method for manufacturing a heat exchanger assembly that includes providing a tube having an internal surface and an external surface. Disposing an aluminum-based component adjacent to the tube, the aluminum-based component having an aluminum-based material that has a magnesium content that is above 0.3%. Applying a brazing flux during a controlled atmosphere brazing process so as to join the aluminum-based component to the tube.

Each of the above aspects of the present invention provides the advantage of providing a heat exchanger that uses a fin material that is higher in strength than fin materials that are used with known CAB processes.

Each of the above aspects of the present invention provides the advantage of maintaining the strength of a heat exchanger while also reducing in weight and cost the heat exchanger.

The present invention, together with attendant objects and advantages, will be best understood with reference to the detailed description below in connection with the attached drawings.

### BRIEF DESCRIPTION OF THE DRAWINGS

FIG. 1 is a partial perspective view of an embodiment of a heat exchanger assembly according to the present invention;

FIG. 2 is a sectional view taken along line 2-2 of FIG. 1;

FIG. 3 is an enlarged view of circle 3 of FIG. 2; and

FIG. 4 is a sectional view of a second embodiment of a heat exchanger assembly according to the present invention.

### DETAILED DESCRIPTION OF THE INVENTION

An embodiment of a heat exchanger assembly 10, according to the present invention, is shown in FIG. 1. The heat exchanger assembly 10 is a condenser for an air conditioning system (not shown) of a vehicle such as an automotive vehicle (not shown). The heat exchanger assembly 10 may be a condenser, evaporator, heater core, radiator or transmission oil cooler.

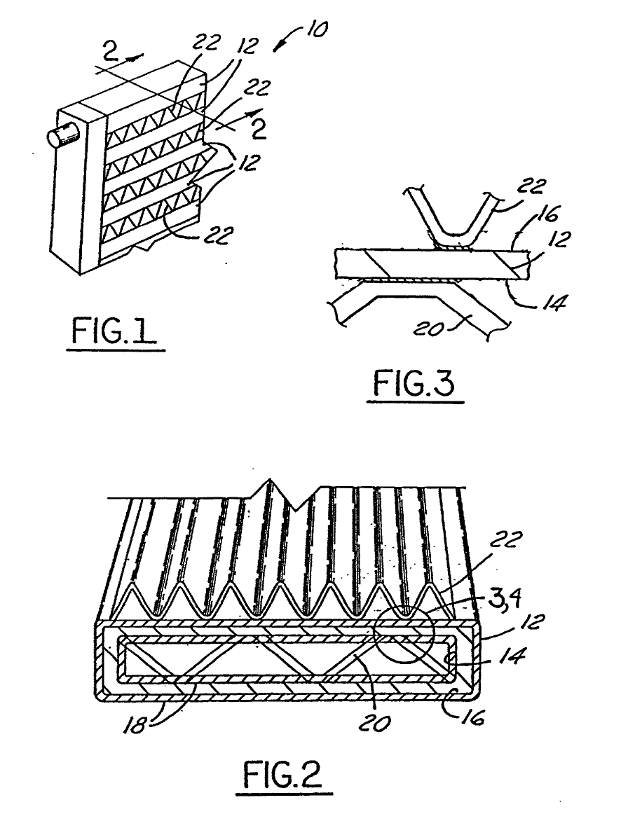

As shown in FIG. 2, the heat exchanger assembly 10 includes at least one, preferably a plurality, of tubes 12 or plates made of an aluminum-based material. By “aluminum-based” with respect to the tube 12 and components like the fins 22 mentioned below, is meant that the aluminum-based composition includes mostly aluminum, but may be alloyed with other metals like silicon, copper, magnesium, zinc and so forth. Each tube 12 extends longitudinally and is generally oval in shape. The aluminum based core material of tube 12 is preferably selected from the Aluminum Association 1XXX, 3XXX, 5XXX and 6XXX series aluminum alloys. The core aluminum material may and desirably does include magnesium. Preferably, the core material includes magnesium in an amount less than 3% by weight.

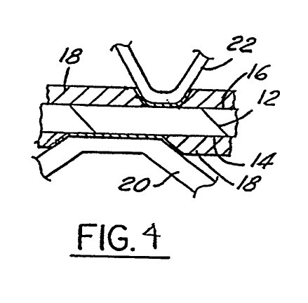

Each tube 12 has an internal surface 14 and an external surface 16. In those situations when the heat exchanger assembly 10 is a condenser, the tubes 12 are not clad as shown in FIG. 3. In those situation when the heat exchanger assembly is not a condenser, such as an evaporator, heater core, radiator or transmission oil cooler, the internal tube surface 14 and/or external tube surface 16 each have a silicon-aluminum composition cladding thereon, such as the cladding known as Aluminum Association 4343 or 4045, as shown in FIG. 4. It should be appreciated that the composition cladding 18 is made by rolling aluminum sheets of different alloys which is clad to the surfaces 14 and 16 as desired of the tube 12 by methods well known in the art.

As shown in FIGS. 1-3, the heat exchanger assembly 10 includes at least one aluminum based fin component disposed adjacent the tube 12, which is to be joined by brazing to the tube 12. For example, the heat exchanger assembly 10 may include a turbulator 20 disposed within the tube 12 adjacent the internal surface 14. The turbulator 20 extends longitudinally and laterally in a series of undulations. The turbulator 20 breaks up the flow of fluid passing through the tube 12 in use to effect heat transfer. In another example, the heat exchanger assembly 10 includes a fin 22 disposed adjacent the external surface 16 of tube 12. The fin 22 extends longitudinally and laterally in a series of undulations. The turbulator 20 and fin 22 are each made of an aluminum-based material such as the Aluminum Association 5XXX or 6XXX series aluminum alloys. In the case of using the 5XXX series of aluminum alloys, the alloy has a magnesium content of 1.2 to 2%. In the case of using the 6XXX series of aluminum alloys, the alloy has a magnesium content of 0.2 to 1.2%. It is contemplated that the fin 22 can be an aluminum alloy that has a magnesium content ranging from 0.4 to 3%. The turbulator 20 and the fin 22 may be clad with a silicon-aluminum composition cladding, such as the cladding known as Aluminum Association 4343 or 4045. Generally, however, such cladding is not used for turbulator 20 and fin 22.

For manufacture of the heat exchanger assembly 10, the turbulator 20 and fin 22 are joined to the tube 12 using a CAB furnace brazing process. A brazing flux is applied to a joint between the tube 12 and any component to be joined to the tube 12 by brazing, i.e., the turbulator 20 or fin 22. An example of a suitable brazing flux is disclosed in U.S. Pat. No. 5,806,752, the entire contents of which are incorporated herein by reference. The brazing flux can be applied onto the joint area by such ways as brushing, dipping, and spraying, the latter being preferred because it provides more uniform application.

For manufacture of the heat exchanger assembly 10, the turbulator 20 and fin 22 are joined to the tube 12 using a CAB furnace brazing process. In the CAB process, the heat exchanger assembly 10, with flux applied in at least the areas of the to be formed braze joints, is placed on a braze holding furnace fixture and preheated, for example, to a temperature in a range from about 425° F. to about 474° F. The heat exchanger assembly 10 and braze holding furnace fixture are transferred to a prebraze chamber where it is soaked for about 3-15 minutes at about 750° F. Subsequently, the hot heat exchanger assembly 10 and braze holding furnace fixture are transferred to a conveyor and moved through a CAB furnace which is purged by applying a nitrogen gas at inside the CAB furnace. It should be noted that a conveyor system may be used to convey the heat exchanger assembly 10 to one or more stations to perform all or substantially all of the described processes.

In the CAB furnace, the heat exchanger assembly 10 is kept for 2-3 minutes at about 1095° F.-1130° F. The brazed heat exchanger assembly 10 is then cooled, removed and applied for its intended use. The end result of the process is that a strong bond between the fins 22 and the tubes 12 is formed without requiring the thickness of the fins 22 to be increased. In particular, the fins preferably have a thickness of approximately 0.002″ which is less than the fin thicknesses ranging from 0.003″ to 0.004″ used in previous processes.

The foregoing description is provided to illustrate the invention, and is not to be construed as a limitation. Numerous additions, substitutions and other changes can be made to the invention without departing from its scope as set forth in the appended claims.

We claim:

1. A heat exchanger assembly comprising:
a tube comprising an internal surface and an external surface;
an aluminum-based component disposed adjacent to said tube, said aluminum-based component comprising an aluminum-based material that has a magnesium content that is above 0.3%;
wherein said aluminum-based component is joined to said tube using a brazing flux applied during a controlled atmosphere brazing process.

2. The heat exchanger assembly of claim 1, wherein said magnesium content ranges from above 0.3% to about 3%.

3. The heat exchanger assembly of claim 2, wherein said magnesium content ranges from about 0.4% to about 3%.

4. The heat exchanger assembly of claim 1, wherein said aluminum-based component comprises a fin disposed adjacent to said external surface.

5. The heat exchanger assembly of claim 1, wherein said aluminum-based component comprises a turbulator disposed adjacent to said internal surface.

6. The heat exchanger assembly of claim 1, wherein said aluminum based material comprises Aluminum Association 5XXX series aluminum alloy.

7. The heat exchanger assembly of claim 1, wherein said aluminum based material comprises Aluminum Association 6XXX series aluminum alloy.

8. The heat exchanger assembly of claim 4, further comprising:
a cladding positioned upon said external surface, wherein said cladding lies between said fin and said external surface of said tube.

9. The heat exchanger assembly of claim 5, further comprising:
a cladding positioned upon said internal surface, wherein said cladding lies between said turbulator and said internal surface of said tube.

10. The heat exchanger assembly of claim 8, wherein said cladding comprises a silicon-aluminum composition cladding.

11. The heat exchanger assembly of claim 9, wherein said cladding comprises a silicon-aluminum composition cladding.

12. The heat exchanger assembly of claim 1, wherein said tube comprises a second aluminum-based material.

13. The heat exchanger assembly of claim 12, wherein said second aluminum-based material comprises mostly aluminum an d is alloyed with a metal chosen from the group consisting of silicon, copper, magnesium and zinc.

14. The heat exchanger assembly of claim 12, wherein said second aluminum-based material comprises a material chosen from the group consisting of Aluminum Association 1XXX, 3XXX, 5XXX and 6XXX series aluminum alloys.

15. The heat exchanger assembly of claim 13, wherein said metal is magnesium.

16. The heat exchanger assembly of claim 15, wherein said magnesium constitutes about 0.4% to 2.5% by weight of said tube.

17. The heat exchanger assembly of claim 1, further comprising a condenser.

18. The heat exchanger assembly of claim 1, further comprising an evaporator.

19. The heat exchanger assembly of claim 1, further comprising a heater core.

20. The heat exchanger assembly of claim 1, further comprising a transmission oil cooler.

21. The heat exchanger assembly of claim 1, further comprising a radiator.

22. A method for manufacturing a heat exchanger assembly comprising:
providing a tube comprising an internal surface and an external surface;
disposing an aluminum-based component adjacent to said tube, said aluminum-based component comprising an aluminum-based material that has a magnesium content that is above 0.3%; and
applying a brazing flux during a controlled atmosphere brazing process so as to join said aluminum-based component to said tube.

23. The method of claim 22, wherein said magnesium content ranges from above 0.3% to about 3%.

24. The method of claim 23, wherein said magnesium content ranges from about 0.4% to about 3%.

25. The method of claim 22, wherein said disposing comprises disposing a fin adjacent to said external surface.

26. The method of claim 22, wherein said disposing comprises disposing a turbulator adjacent to said internal surface.

27. The method of claim 22, wherein said aluminum based material comprises Aluminum Association 5XXX series aluminum alloy.

28. The method of claim 22, wherein said aluminum based material comprises Aluminum Association 6XXX series aluminum alloy.

29. The method of claim 25, further comprising:
positioning a cladding upon said external surface so as to lie between said fin and said external surface of said tube.

30. The method of claim 26, further comprising:
positioning a cladding upon said internal surface so as to lie between said turbulator and said internal surface of said tube.

31. The method of claim 22, wherein said tube comprises a second aluminum-based material.

32. The method of claim 31, wherein said tube comprises magnesium.

33. The method of claim 32, wherein said magnesium constitutes about 0.4% to 2.5% by weight of said tube.
